(19) United States
(12) Patent Application Publication
(10) Pub. No.: US 2011/0269871 A1
(43) Pub. Date: Nov. 3, 2011

(54) RUBBER COMPOSITION AND PNEUMATIC TIRE USING THE SAME

(75) Inventors: Yoshiaki Kirino, Kanagawa-ken (JP); Hiroki Sugimoto, Kanagawa-ken (JP)

(73) Assignee: The Yokohama Rubber Co., Ltd., Tokyo (JP)

(21) Appl. No.: 13/096,906

(22) Filed: Apr. 28, 2011

(30) Foreign Application Priority Data
Apr. 30, 2010 (JP) 2010-105220
Jul. 30, 2010 (JP) 2010-171280

(51) Int. Cl. C08L 77/06; C08L 9/06; C08J 5/14; C08L 9/00; C08K 3/04; C08K 3/36

(52) U.S. Cl. 523/156; 524/514; 524/495; 524/493

(57) ABSTRACT

A rubber composition including a diene rubber and, per 100 parts by mass thereof, from 5 to 100 parts by mass of an inorganic filler, and from 0.5 to 40 parts by mass of a polyether polyamide elastomer, and a pneumatic tire using this rubber composition in a cap tread of a tread.

### PRIORITY CLAIM

Priority is claimed to Japan Patent Application Serial No. 2010-105220 filed on Apr. 30, 2010, and Japan Patent Application Serial No. 2010-171280 filed on Jul. 30, 2010.

### BACKGROUND

1. Technical Field

The present technology relates to a rubber composition and a pneumatic tire using the same, and particularly relates to a rubber composition that displays superior steering stability due to having a high hardness and reduced heat build-up, and a pneumatic tire using the same.

2. Related Art

While various performance factors are demanded of pneumatic tires, balancing high levels of performance in both steering stability and fuel consumption are particularly desired. Generally, increasing the hardness of a tire tread has been effective in enhancing steering stability. Techniques are known for increasing the hardness such as, for example, compounding a rubber composition with a resin such as polypropylene. However, there is a problem with such techniques in that heat build-up is negatively affected, which leads to fuel consumption performance being negatively affected. Thus, enhancing both steering stability and fuel consumption performance is equivalent to enhancing two conflicting characteristics and achieving both has been a technically difficult issue.

### SUMMARY

The present technology provides a rubber composition that displays superior steering stability due to having a high hardness and reduced heat build-up, and a pneumatic tire using the same. The technology is achieved by compounding a specific amount of an inorganic filler and a specific amount of a polyether polyamide elastomer in a diene rubber.

The present technology is described hereinafter.

A rubber composition can include a diene rubber and, per 100 parts by mass thereof, from 5 to 100 parts by mass of an inorganic filler, and from 0.5 to 40 parts by mass of a polyether polyamide elastomer.

The inorganic filler in the rubber composition can include silica.

A compounded amount of the polyether polyamide elastomer in the rubber composition can be from 1 to 15 parts by mass per 100 parts by mass of the diene rubber composition.

The rubber composition can include from 0.5 to 10 parts by mass of a silane coupling agent per 100 parts by mass of the diene rubber composition. The silane coupling agent can be an alkoxysilane having a mercapto group. For example, the alkoxysilane having a mercapto group can be γ-mercaptopropyltrimethoxysilane.

A cap tread for a pneumatic tire can be formed which uses the rubber composition described above.

According to the present technology, a specific amount of an inorganic filler and a specific amount of a polyether polyamide elastomer can be compounded in a diene rubber. Therefore, a rubber composition that displays superior steering stability due to having a high hardness and reduced heat build-up, and a pneumatic tire using the same, can be provided.

### BRIEF DESCRIPTION OF THE DRAWING

FIG. 1 is a partial cross-sectional view of an example of a pneumatic tire for a passenger vehicle according to the present technology.

### DETAILED DESCRIPTION

The present technology is explained in further detail below.

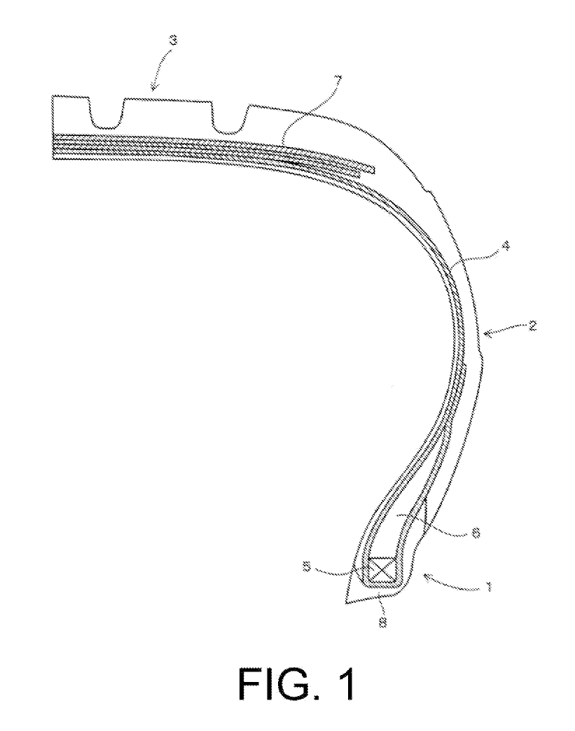

In FIG. 1, the pneumatic tire is shown being formed from a pair of right and left bead portions 1,1, a pair of right and left side walls 2, and a tread 3 extending between both of the side walls 2. A carcass layer 4 embedded with fiber cords is mounted between the bead portions 1,1. An end of the carcass layer 4 is folded over and up from a tire inner side to a tire outer side around a bead core 5 and a bead filler 6. In the tread 3, a belt layer 7 is provided along a circumference of the tire on an outer side of the carcass layer 4. Additionally, rim cushions 8 are provided in portions of the bead portions 1 that are in contact with a rim.

The rubber composition of the present technology described below can be used for various tire-use members as those described above, and can be preferably used for the tread 3 (particularly a cap tread).

### Diene Rubber

Any diene rubber that can be compounded in a rubber composition may be used as a diene rubber component for use in the present technology.

Examples of the diene rubber include natural rubber (NR), isoprene rubber (IR), butadiene rubber (BR), styrene-butadiene copolymer rubber (SBR), acrylonitrile-butadiene copolymer rubber (NBR), and the like. One of these may be used alone, or two or more may be used in any combination. Additionally, a molecular mass and a microstructure of the rubber component is not particularly limited and may by terminally modified by an amine, amide, silyl, alkoxysilyl, carboxyl, or hydroxyl group, or the like, or be epoxidated.

Among these diene rubbers, from a perspective of effectiveness of the present technology, SBR or BR is preferably compounded as the diene rubber component.

### Inorganic Filler

Examples of the inorganic filler for use in the present technology include carbon black, silica, clay, talc, calcium carbonate, and the like. Among these, carbon black and silica are particularly preferable.

The carbon black for use in the present technology is not particularly limited, and any carbon black normally compounded in rubber compositions can be used. Examples of the carbon black include those that have a nitrogen specific surface area (N₂SA) of from 30 to 200 m²/g, and preferably from 50 to 150 m²/g. The nitrogen specific surface area (N₂SA) is a value calculated in accordance with Japanese Industrial Standard (JIS) K6217-2.

Additionally, the silica for use in the present technology is not particularly limited, and any silica normally compounded in rubber compositions can be used. Examples of the silica include wet method silica, dry method silica, surface treated silica, and the like. A BET (Brunauer Emmett Teller) specific surface area of the silica (measured in accordance with Appendix E of JIS K6430) is, from the perspective of the effectiveness of the present technology, for example, from 50 to 300 m²/g, and preferably from 150 to 250 m²/g.

### Polyether Polyamide Elastomer

The polyether polyamide elastomer for use in the present technology is a known polyether polyamide elastomer and, for example, can be the polyether polyamide elastomer that is described in detail along with a manufacturing method thereof in WO/2007/145324. Said polyether polyamide elastomer has a hard segment formed from polyamide and a soft segment formed from a polyether. A particularly preferable polyether polyamide elastomer, from the perspective of the effectiveness of the present technology is a polyether polyamide elastomer having a hard segment formed from Nylon 12 and a soft segment formed from a polyether, wherein a weight-average molecular weight is from 10,000 to 200,000. Such polyether polyamide elastomers, such as XPA, manufactured by Ube Industries, Ltd., that are commercially available can be used. While the functions/effects of the polyether polyamide elastomer are not clear at this point in time, according to the research performed by the inventors, the hard segment portion in the polyether polyamide elastomer interacts with the inorganic filler, such as silica, and the soft segment portion provides affinity for the rubber component. Therefore, it is presumed that dispersibility of the inorganic filler is enhanced, which leads to the effectiveness of the present technology.

### Silane Coupling Agent

If silica is used as the inorganic filler in the present technology, a silane coupling agent is also preferably used. Examples of the silane coupling agent for use include sulfur-containing silane coupling agents. From the perspective of the effectiveness of the present technology, the silane coupling agent is preferably an alkoxysilane having a mercapto group, and γ-mercaptopropyltrimethoxysilane is optimal.

A compounded amount of the silane coupling agent is, for example, from 0.5 to 10 parts by mass and preferably from 1.0 to 4.0 parts by mass per 100 parts by mass of the diene rubber.

### Compounding Ratio of the Rubber Composition

The rubber composition of the present technology includes the diene rubber and, per 100 parts by mass thereof, from 5 to 100 parts by mass of the inorganic filler, and from 0.5 to 40 parts by mass of the polyether polyamide elastomer.

It is not preferable that the compounded amount of the inorganic filler be less than 5 parts by mass, because reinforcement action will decline and the desired physical characteristics will not be obtainable. On the other hand, if the compounded amount exceeds 100 parts by mass, dispersion of the filler will be negatively affected and the physical characteristics will decline.

If the compounded amount of the polyether polyamide elastomer is less than 0.5 parts by mass, the compounded amount will be insufficient, and the effectiveness of the present technology will not be achievable. On the other hand, if the compounded amount exceeds 40 parts by mass, a tan δ (60° with respect to an increased value of the hardness will be negatively affected to a significant degree.

It is more preferable that from 30 to 80 parts by mass of the inorganic filler be compounded per 100 parts by mass of the diene rubber.

It is more preferable that from 1 to 15 parts by mass of the polyether polyamide elastomer be compounded per 100 parts by mass of the diene rubber.

In addition to the aforementioned components, the rubber composition of the present technology can also contain various types of additives that are commonly added for tires or for other rubber compositions, such as vulcanizing and cross-linking agents, vulcanizing and cross-linking accelerators, various types of oils, antiaging agents, plasticizers, and the like. The additives may be kneaded in according to a common method and used in vulcanizing or cross-linking. Compounded amounts of these additives may be any conventional standard amount, so long as the object of the present technology is not hindered.

From the perspective of the effectiveness of the present technology, it is preferable that each of the components be mixed in the following order: First only the diene rubber, the silica, and the silane coupling agent are mixed for two minutes or longer at a temperature of 150° C. or higher, and preferably from 160 to 170° C.; then, after the coupling reaction between the diene rubber and the silica has progressed, the polyether polyamide elastomer is added. A greater amount of the polyether polyamide elastomer can be compounded by mixing according to a method such as that described above, which makes it possible to obtain excellent physical characteristics.

Examples of applications of the rubber composition of the present technology include conveyor belts, hoses, tires, and the like, but tire applications are particularly preferable. Moreover, the rubber composition of the present technology is particularly suitable for use in treads (especially cap treads).

Additionally, the rubber composition of the present technology can be used to manufacture a pneumatic tire according to a conventional method for manufacturing pneumatic tires.

### EXAMPLES

The present technology is further explained in detail with reference to the Working Examples and Comparative Examples described hereinafter, but the present technology is not limited by these examples.

### Working Examples 1 to 5 and Comparative Examples 1 to 5

### Preparation of Samples

According to the composition (parts by mass) shown in Table 1, the components, other than the vulcanization components (vulcanization accelerator and sulfur), were kneaded for five minutes at 165° C. in a 1.7 liter sealed Banbury Mixer. Then the composition was discharged from the mixer and cooled to room temperature. Thereafter, the rubber composition was obtained by placing the composition in an open roll, adding the vulcanization components, and kneading. Next, the rubber composition thus obtained was vulcanized in a predetermined mold at 160° C. for 20 minutes to fabricate a vulcanized rubber test sample. Then the vulcanized rubber test sample was subjected to the test methods shown below to measure the physical characteristics thereof.

Hardness (20° C.): Measured at 20° C. in accordance with JIS 6253. The results are shown as index values with the value of Comparative Example 1 being 100. Larger index values indicate higher hardness and superior steering stability.

tan δ (60° C.): Measured using a viscoelasticity spectrometer manufactured by Iwamoto Seisakusho under the following conditions: elongation deformation strain rate=10%±2%, frequency=20 Hz, and temperature=60° C. The results are shown as index values with the value of Comparative Example 1 being 100. Smaller index values indicate reduced heat build-up.

The results are shown in Table 1.

TABLE 1

| | W.E. 1 | W.E 2 | W.E 3 | W.E 4 | W.E 5 | C.E. 1 | C.E. 2 | C.E. 3 | C.E. 4 | C.E. 5 |
|---|---|---|---|---|---|---|---|---|---|---|
| BR*¹ | 30 | 30 | 30 | 30 | 30 | 30 | 30 | 30 | 30 | 30 |
| SBR*² | 96.25 | 96.25 | 96.25 | 96.25 | 96.25 | 96.25 | 96.25 | 96.25 | 96.25 | 96.25 |
| Silica*³ | 60 | 60 | 60 | 60 | 60 | 60 | 60 | 60 | 60 | 60 |
| Carbon black*⁴ | 10 | 10 | 10 | 10 | 10 | 10 | 10 | 10 | 10 | 10 |
| Silane coupling agent*⁵ | 2.5 | 2.5 | 2.5 | 2.5 | 2.5 | 2.5 | 2.5 | 2.5 | 2.5 | 2.5 |
| Polyether polyamide elastomer*⁶ | 2.5 | 5 | 1 | 0.5 | 10 | — | — | — | — | — |
| Polypropylene*⁷ | — | — | — | — | — | — | 2.5 | 5 | — | — |
| Copolymer-1*⁸ | — | — | — | — | — | — | — | — | 3.0 | — |
| Copolymer-2*⁹ | — | — | — | — | — | — | — | — | — | 3.0 |
| Stearic acid*¹⁰ | 1 | 1 | 1 | 1 | 1 | 1 | 1 | 1 | 1 | 1 |
| Zinc oxide*¹¹ | 3 | 3 | 3 | 3 | 3 | 3 | 3 | 3 | 3 | 3 |
| Antiaging agent*¹² | 1 | 1 | 1 | 1 | 1 | 1 | 1 | 1 | 1 | 1 |
| Sulfur*¹³ | 2 | 2 | 2 | 2 | 2 | 2 | 2 | 2 | 2 | 2 |
| Vulcanization accelerator-1*¹⁴ | 2 | 2 | 2 | 2 | 2 | 2 | 2 | 2 | 2 | 2 |
| Vulcanization accelerator-2*¹⁵ | 1 | 1 | 1 | 1 | 1 | 1 | 1 | 1 | 1 | 1 |
| Test results | | | | | | | | | | |
| Hardness (20° C.) | 103 | 105 | 102 | 100 | 109 | 100 | 103 | 106 | 96 | 97 |
| tan δ (60° C.) | 108 | 115 | 106 | 104 | 125 | 100 | 118 | 127 | 98 | 98 |
| Hardness (20° C.)/tan δ (60° C.) | 95 | 91 | 96 | 96 | 87 | 100 | 87 | 83 | 98 | 99 |

Notes
to Table 1: In Table 1, “ W.E.” is an abbreviation for “Working Example” and “C.E.” is an abbreviation for “Comparative Example”.

### Working Examples 6 to 10 and Comparative Examples 6 and 7

### Preparation of Sample

According to the composition (parts by mass) shown in Table 2, only the BR, the SBR, the silica, and the silane coupling agent were put into a sealed 1.7 L Banbury Mixer and kneaded for two minutes at 165° C. Next, after the coupling reaction between the diene rubber and the silica had progressed, the components other than those mentioned above and the vulcanization components (the vulcanization accelerator and sulfur) were mixed for 3 minutes at 150° C. Then, the composition was discharged from the mixer and cooled to room temperature. Thereafter, the rubber composition was obtained by placing the composition in an open roll, adding the vulcanization components, and kneading. Next, the rubber composition thus obtained was vulcanized in a predetermined mold at 160° C. for 20 minutes to fabricate a vulcanized rubber test sample. Then the vulcanized rubber test sample was subjected to the test methods described above to measure the physical characteristics thereof. The results are shown as index values with the hardness (20° C.) and the tan δ (60° C.) of Comparative Example 6 being 100.

The results are shown in Table 2.

TABLE 2

| | W.E. 6 | W.E. 7 | W.E. 8 | W.E. 9 | W.E. 10 | C.E. 6 | C.E. 7 |
|---|---|---|---|---|---|---|---|
| BR*¹ | 30 | 30 | 30 | 30 | 30 | 30 | 30 |
| SBR*² | 96.25 | 96.25 | 96.25 | 96.25 | 96.25 | 96.25 | 96.25 |
| Silica*³ | 60 | 60 | 60 | 60 | 60 | 60 | 60 |
| Carbon black*⁴ | 10 | 10 | 10 | 10 | 10 | 10 | 10 |
| Silane coupling agent*⁵ | 2.5 | 2.5 | 2.5 | 2.5 | 2.5 | 2.5 | 2.5 |
| Polyether polyamide elastomer*⁶ | 2.5 | 5.0 | 10.0 | 15.0 | 40.0 | — | 45.0 |
| Polypropylene*⁷ | — | — | — | — | — | — | — |
| Stearic acid*¹⁰ | 1 | 1 | 1 | 1 | 1 | 1 | 1 |
| Zinc oxide*¹¹ | 3 | 3 | 3 | 3 | 3 | 3 | 3 |
| Antiaging agent*¹² | 1 | 1 | 1 | 1 | 1 | 1 | 1 |
| Sulfur*¹³ | 2 | 2 | 2 | 2 | 2 | 2 | 2 |
| Vulcanization accelerator-1*¹⁴ | 2 | 2 | 2 | 2 | 2 | 2 | 2 |
| Vulcanization accelerator-2*¹⁵ | 1 | 1 | 1 | 1 | 1 | 1 | 1 |
| Test results | | | | | | | |
| Hardness (20° C.) | 102 | 105 | 109 | 112 | 125 | 100 | 126 |
| tan δ (60° C.) | 88 | 90 | 106 | 108 | 119 | 100 | 123 |
| Hardness (20° C.)/tan δ (60° C.) | 116 | 117 | 103 | 104 | 105 | 100 | 102 |

Notes
to Table 2: In Table 2, “W.E.” is an abbreviation for “Working Example” and “C.E.” is an abbreviation for “Comparative Example”.

1: BR (BR1220, manufactured by Zeon Corporation)
2: SBR (VSR5025, manufactured by Bayer Holding Ltd., solution SBR; Oil extender content=37.5 parts by mass per 100 parts by mass of the SBR)
3: Silica (Nipsil AQ, manufactured by Tosoh Silica Corporation; BET specific surface area=200 m²/g)
4: Carbon black (SEAST 7HM, manufactured by Tokai Carbon Co., Ltd.; N₂SA=100 m²/g)
5: Silica coupling agent (KBM803, manufactured by Shin-Etsu Chemical Co., Ltd.; γ-mercaptopropyltrimethoxysilane)
6: Polyether polyamide elastomer (XPA, manufactured by Ube Industries, Ltd.)
7: Polypropylene (Idemitsu PP, manufactured by Idemitsu Kosan, Co., Ltd.)
8: Copolymer 1 (carboxylic acid modified polyisoprene (LIR-410, manufactured by Kuraray Chemical; number average molecular weight=25,000) and ε-caprolactam were fed into an autoclave at a weight ratio of 2:1 and polymerization reacted for 10 minutes at 250° C. Thereafter, acetone was added, the unreacted ε-caprolactam was washed off, and the product was dried. Thus, the copolymer 1 was obtained.)
9: Copolymer 2 (other than modifying the weight ratio of the carboxylic acid modified polyisoprene to the ε-caprolactam to 1:1, the copolymer 2 was obtained via the same fabrication method used for the copolymer 1.)
10: Stearic acid (Beads Stearic Acid, manufactured by NOF Corporation)
11: Zinc oxide (Zinc Oxide #3, manufactured by Seido Chemical Industry Co., Ltd.)
12: Antiaging agent (Nocrac 6C, manufactured by Ouchi Shinko Chemical Industrial Co., Ltd.)
13: Sulfur (“Golden Flower” Oil Treated Sulfur Powder, manufactured by Tsurumi Chemical)
14: Vulcanization accelerator-1 (Noccelar CZ-G, manufactured by Ouchi Shinko Chemical Industrial Co., Ltd.)
15: Vulcanization accelerator-2 (Noccelar D, manufactured by Ouchi Shinko Chemical Industrial Co., Ltd.)

As is clear from Tables 1 and 2 above, the rubber compositions prepared in Working Examples 1 to 10 had a specific amount of the inorganic filler and a specific amount of the polyether polyamide elastomer in the diene rubber. Therefore, compared with Comparative Examples 1 and 6, which are representative of the conventional technology, the hardness is increased, and superior steering stability is provided. Additionally, the negative effect on heat build-up is suppressed to a minimum. Specifically, considering the ratio of the hardness (20° C.) to the tan δ (60° C.), an amount of increase of the tan δ (60° C.) with respect to the increase in the hardness (20° C.) is suppressed compared to that in the Comparative Examples.

Comparative Examples 2 and 3 are examples in which a resin (polypropylene) was compounded in place of the polyether polyamide elastomer. In these cases, while hardness was enhanced, heat build-up was negatively affected.

Comparative Examples 4 and 5 are examples in which a different polyamide resin (the resin described in Japanese Unexamined Patent Application No. 2010-001438) was compounded in place of the polyether polyamide elastomer. In these cases hardness was not enhanced. According to the research performed by the inventors, it was presumed that while the polyamide resin interacts with the inorganic filler, it does not display affinity for the rubber component. Specifically, it became clear that the desired effectiveness could not be achieved using a polyamide resin other than the polyether polyamide elastomer of the present technology.

Comparative Example 7 is an example in which the compounded amount of the polyether polyamide elastomer exceeded the maximum amount stipulated in the present technology. Therefore, mixability in the Banbury Mixer and processability when molding were negatively affected.

What is claimed is:

1. A rubber composition comprising a diene rubber and, per 100 parts by mass thereof, from 5 to 100 parts by mass of an inorganic filler, and from 0.5 to 40 parts by mass of a polyether polyamide elastomer.

2. The rubber composition according to claim 1, wherein the inorganic filler comprises silica.

3. The rubber composition according to claim 2, wherein a compounded amount of the polyether polyamide elastomer is from 1 to 15 parts by mass per 100 parts by mass of the diene rubber composition.

4. The rubber composition according to claim 1, wherein a compounded amount of the polyether polyamide elastomer is from 1 to 15 parts by mass per 100 parts by mass of the diene rubber composition.

5. The rubber composition according to claim 4, further comprising from 0.5 to 10 parts by mass of a silane coupling agent per 100 parts by mass of the diene rubber composition.

6. The rubber composition according to claim 1, further comprising from 0.5 to 10 parts by mass of a silane coupling agent per 100 parts by mass of the diene rubber composition.

7. The rubber composition according to claim 6, wherein the silane coupling agent is an alkoxysilane having a mercapto group.

8. The rubber composition according to claim 7, wherein the alkoxysilane having a mercapto group is γ-mercaptopropyltrimethoxysilane.

9. The rubber composition according to claim 1, wherein the diene rubber comprises at least one of butadiene rubber (BR) and styrene-butadiene copolymer rubber (SBR).

10. The rubber composition according to claim 1, wherein the filler comprises carbon black having a nitrogen specific surface area (N2SA) of from 30 to 200 m2/g.

11. The rubber composition according to claim 10, wherein the carbon black has a nitrogen specific surface area (N2SA) of from 50 to 150 m2/g.

12. The rubber composition according to claim 1, wherein the inorganic filler comprises a silica selected from the group consisting of wet method silica, dry method silica, and surface treated silica, and wherein the silica comprises a BET (Brunauer Emmett Teller) specific surface area of from 50 to 300 m2/g.

13. The rubber composition according to claim 12, wherein the silica comprises a BET specific surface area of from 150 to 250 m2/g.

14. The rubber composition according to claim 12, further comprising from 1.0 to 4.0 parts by mass of a silane coupling agent per 100 parts by mass of the diene rubber composition.

15. The rubber composition according to claim 1, wherein the polyether polyamide elastomer comprises a hard segment comprising Nylon 12 and a soft segment comprising a polyether.

16. The rubber composition according to claim 1, wherein the polyether polyamide elastomer comprises a weight-average molecular weight from 10,000 to 200,000.

17. The rubber composition according to claim 1, wherein the organic filler comprises from 30 to 80 parts by mass per 100 parts by mass of the diene rubber.

18. The rubber composition according to claim 1, wherein the polyether polyamide elastomer comprises from 1 to 15 parts by mass per 100 parts by mass of the diene rubber.

19. The rubber composition according to claim 1, wherein the polyether polyamide elastomer comprises a secondarily added component compounded with a mixture of the diene rubber and the inorganic filler.

20. A pneumatic tire using the rubber composition of a claim 1 in a cap tread.
